(19) United States
(12) Patent Application Publication
(10) Pub. No.: US 2026/0344559 A1
(43) Pub. Date: Nov. 5, 2026

(54) Tiltable Outdoor Power Tool

(71) Applicant: Milwaukee Electric Tool Corporation, Brookfield, WI (US)

(72) Inventors: Jonathan A. Cielpluch, Brookfield, WI (US); Bryan J. Edler, Brookfield, WI (US); Brooke E. Duvall, Brookfield, WI (US); Casey D. Garces, Brookfield, WI (US); Matthew D. McGrath, Brookfield, WI (US)

(21) Appl. No.: 19/557,857

(22) Filed: Mar. 5, 2026

Related U.S. Application Data
(60) Provisional application No. 63/767,826, filed on Mar. 6, 2025.
(60) Provisional application No. 63/790,837, filed on Apr. 18, 2025.

(51) Int. Cl. A01C 17/00; A01M 9/00

(52) U.S. Cl. CPC A01C 17/001; A01C 17/005; A01M 9/0061; A01M 9/0084

(57) ABSTRACT

An outdoor power tool includes a frame, a tool assembly, a drive assembly, a traversing element, and a handle assembly. The tool assembly may be supported on the frame. The drive assembly may be supported on the frame below at least a portion of the tool assembly. The traversing element may be movably attached to the frame and define an element axis about which the traversing element moves. The traversing element may further define a vertical axis orthogonal to the element axis and a transverse axis orthogonal to the element axis and the vertical axis. The handle assembly may be attached to the frame and extend rearward therefrom. The outdoor power tool may define a center of gravity. In a first use state, the center of gravity may be disposed along or rearward from the vertical axis.

### CROSS-REFERENCE TO RELATED APPLICATIONS

The present application claims priority to U.S. Provisional Application No. 63/767,826 filed on Mar. 6, 2025 and U.S. Provisional Application No. 63/790,837 filed on Apr. 18, 2025, the disclosure of which is incorporated by reference herein in its entirety.

### FIELD

The present disclosure relates generally to outdoor power tools, such as a walk-behind spreader.

### BACKGROUND

Traditionally, spreading materials like seed and fertilizer has been performed by hand. The material was positioned about a work area by manual broadcasting. Over time, it has become common to replace the human operator with a machine which can broadcast the material. Machine spreaders can more efficiently spread materials over a work area in a shorter duration of time while providing better distribution of the material. However, existing machines are simplistic and rudimentary. Moreover, although existing machines may make certain aspects of spreading easier, considerable may be required from a user (e.g., to balance or push the spreader).

Accordingly, improved spreaders would be desired in the art. In particular, spreaders that improve ease of operation would be advantageous.

### BRIEF DESCRIPTION

Aspects and advantages of the present disclosure will be set forth in part in the following description, or may be obvious from the description, or may be learned through practice of the technology.

In accordance with one embodiment, an outdoor power tool is provided. The outdoor power tool may include a frame, a tool assembly, a drive assembly, a traversing element, and a handle assembly. The tool assembly may be supported on the frame. The drive assembly may be supported on the frame below at least a portion of the tool assembly. The traversing element may be movably attached to the frame and define an element axis about which the traversing element moves. The traversing element may further define a vertical axis orthogonal to the element axis and a transverse axis orthogonal to the element axis and the vertical axis. The handle assembly may be attached to the frame and extend rearward therefrom. The outdoor power tool may define a center of gravity. In a first use state, the center of gravity may be disposed along or rearward from the vertical axis.

In accordance with another embodiment, an outdoor power tool is provided. The outdoor power tool may include a frame, a tool assembly, a traversing element, a spreader blade, a drive assembly, and a handle assembly. The tool assembly may be supported on the frame. The traversing element may be movably attached to the frame and define an element axis about which the traversing element moves. The traversing element may further define a vertical axis orthogonal to the element axis and a transverse axis orthogonal to the element axis and the vertical axis. The spreader blade may be disposed above the traversing element. The drive assembly, may be supported on the frame and include a spinner shaft extending to the spreader blade in mechanical communication therewith to drive blade rotation. The spinner shaft may be disposed forward from the element axis. The handle assembly may be attached to the frame and extending rearward therefrom. The outdoor power tool may define a center of gravity. In a first use state, the center of gravity is disposed along or rearward from the vertical axis. In a first storage state, the center of gravity may be disposed rearward from the vertical axis in the storage state. In the first storage state and the first use state, the center of gravity may be disposed above the element axis.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a front perspective view of a walk-behind power tool in accordance with embodiments of the present disclosure;

FIG. 2 is a side elevation view of the exemplary walk-behind power tool of FIG. 1, wherein the walk-behind power tool is a storage state;

FIG. 3 is a side elevation view of the exemplary walk-behind power tool of FIG. 1, wherein the walk-behind power tool is a use state;

FIG. 4 is a cross-sectional, elevation view of a portion of the exemplary walk-behind power tool of FIG. 1;

FIG. 5 is a side elevation view of the exemplary walk-behind power tool of FIG. 1, wherein the walk-behind power tool is a first storage state;

FIG. 6 is a side elevation view of the exemplary walk-behind power tool of FIG. 1, wherein the walk-behind power tool is a first use state;

FIG. 7 is a side elevation view of the exemplary walk-behind power tool of FIG. 1, wherein the walk-behind power tool is a second storage state; and

FIG. 8 is a side elevation view of the exemplary walk-behind power tool of FIG. 1, wherein the walk-behind power tool is a second use state.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within five degrees greater or less than the stated angle or direction. For example, “generally vertical” includes directions within five degrees of vertical in any direction, e.g., clockwise or counter-clockwise.

As used herein, the terms “operably connected” and “attached” refers to a mechanical or electrical connection between two or more elements, whether they are directly connected to one another, or are connected via one or more intermediate components, such that the mechanical or electrical output of one element is passed directly or indirectly to the operably connected second component.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, aspects of the present walk-behind power tool provide a tiltable tool that is advantageously balanced (e.g., to reduce or minimize a user's efforts to balance the power tool during use, such as in comparison to existing tools). For instance, when empty or unloaded (e.g., within a hopper of the power tool), a center of gravity of the power tool may motivate the power tool to tilt rearward. By contrast, when loaded (e.g., with a predetermined mass of particulate or spreadable material) during use, the center of gravity may motivate the power tool to tilt slightly rearward. Notably, the user may be required to supply very little counterbalancing downward force, such as by resting his or her hands on the handle of the power tool.

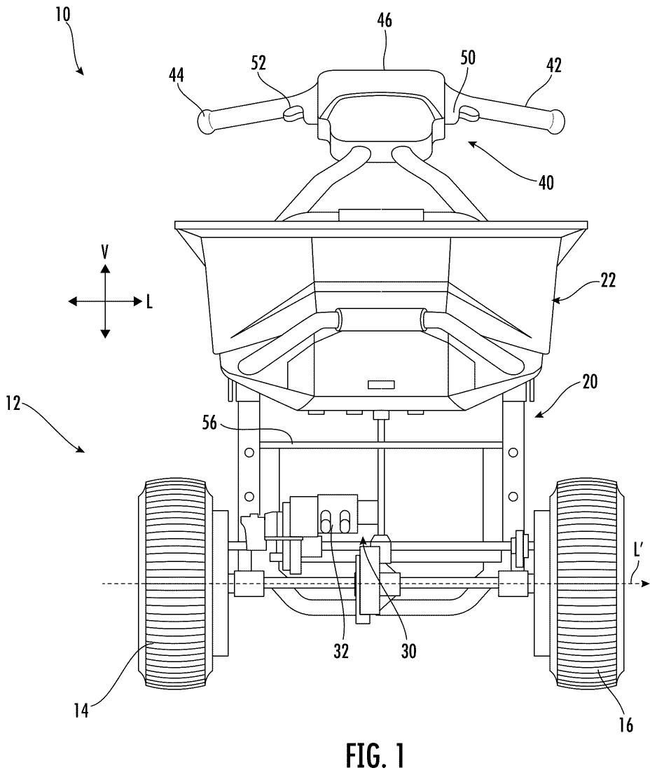

Referring now to the drawings, FIG. 1 illustrates a walk-behind outdoor power tool 10. While the power tool 10 illustrated in FIG. 1 is a spreader that can be used to spread (e.g., distribute) material (e.g., fertilizer, pesticide, or other particulate material) stored in a hopper across a surface (e.g., grass, garden, or the like) as the spreader is traversed over the ground, the present invention further contemplates that the power tool 10 may comprise a lawn mower, a snow thrower or snowblower, a walk-behind fan, an edger, a tiller, a dethatcher, an aerator, a cultivator, or other power tool.

The power tool 10 generally includes a frame 20 and a traversing element 12. The frame 20 can be formed from tubes, plates, and the like. The elements of the frame 20 can be coupled together through weld, fasteners (e.g., threaded fasteners), or the like. The traversing element 12 may be movably attached to the frame 20 for traversing the power tool 10 over an area. For instance, the traversing element 12 may be or include one or more rolling elements that are rotatable about an element axis Aₑ (e.g., parallel to a level, ground-defined lateral direction L). As illustrated in FIG. 1, the traversing element 12 can include one or more wheels such as a first wheel 14 and a second wheel 16. A power tool 10 having only two wheels and no operator seat (such as illustrated in FIG. 1) can also be referred to as a walk-behind power tool. However, while the traversing element 12 is illustrated as the first wheel 14 and the second wheel 16, it should be appreciated that alternatives may also be realized, such as one or more tracks, rollers, or the like.

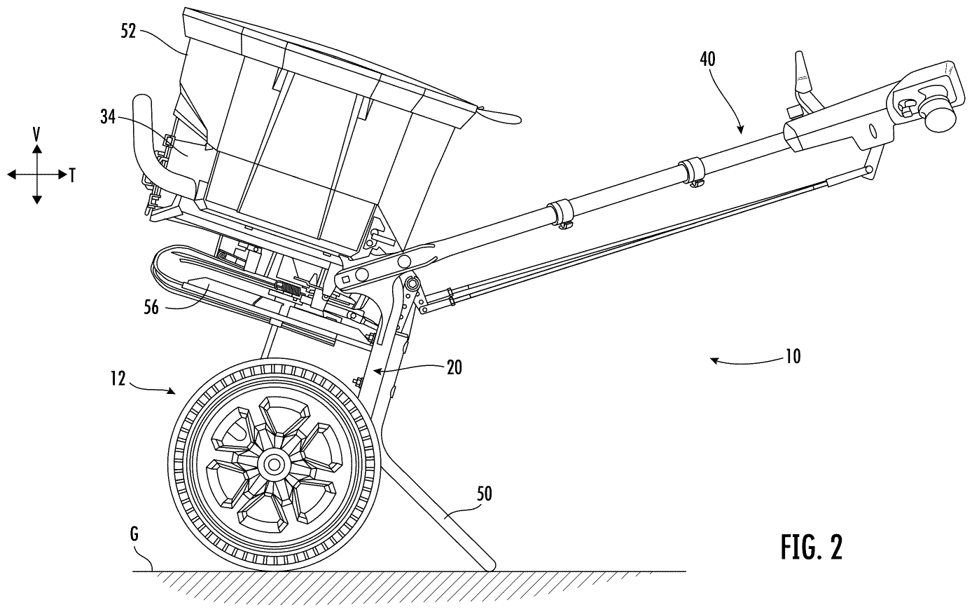

The power tool 10 may further include a handle assembly 40 connected to the frame 20. The handle assembly 40 can be disposed upward and rearward from the traversing element 12. For instance, one or more tubes or bars of the handle assembly 40 may attach to the frame 20 and extend upward and rearward before terminating at or near a grip segment. Separate from or in addition to the handle assembly 40, a kickstand 50 may be connected to the frame 20. For instance, one or more tubes or bars of the kickstand 50 may attach to the frame 20 (e.g., below the handle assembly 40) downward and rearward before terminating at a contact segment to rest against the ground G (FIG. 2) or surface on which power tool 10 is supported (e.g., in a storage state, as will be described in greater detail below).

The power tool 10 can further generally include a drive assembly 30 which propels the traversing element 12 and potentially the tool assembly 22. By way of non-limiting example, the drive assembly 30 can include a motor 32 (such as an electric motor as illustrated), an engine, or the like. For embodiments where the drive assembly 30 comprises the electric motor, the power tool 10 can further include one or more batteries 34, which provide electrical power to the electric motor 32. In a particular embodiment, the one or more batteries can include a single battery. In another embodiment, the one or more batteries can include a plurality of batteries. The battery or batteries may be removable, permanently installed, or a combination thereof. The batteries may also be usable on different components other than the power tool 10, such that they can be swappable between different types of tools. The electric motor can include, for example, a brushless DC motor. The power tool 10 may also be able to traverse ground G (i.e., the traversing element 12 can move) even when the electric motor 32 or other drive assembly 30 is not powering said movement. This can enable both manual and powered operation of the power tool, such that it is still functional even if the power source (e.g., battery) runs out or is removed.

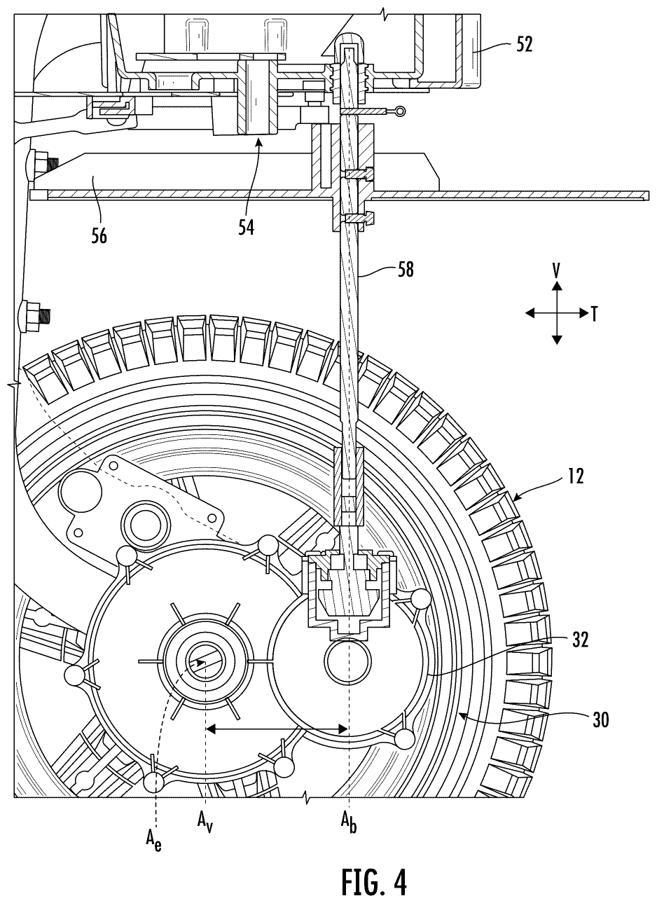

A tool assembly 22 is supported on the frame 20. In FIG. 1 in which the power tool 10 is a spreader, the tool assembly 22 includes a hopper 52, which defines a receiving area which receives a material to be broadcast by the spreader. As shown, the hopper 52 may be disposed above the traversing element 12 and, in particular, above the element axis Aₑ. Turning briefly to FIG. 4, the hopper 52 includes one or more dispersion outlets (e.g., particulate exhaust 54) for releasing the material from the receiving area.

As disclosed herein, the hopper 52 can include a variety of mechanisms and configurations for controlling the release of the material from the receiving area via the one more dispersion outlets or subsequent dispersion from the tool 10. In the illustrated embodiments, a spreader blade 56 is included below the hopper 52. As shown, the spreader blade 56 may be disposed above the traversing element 12. Generally, the spreader blade 56 may be rotatable about a blade axis A_{b} (e.g., parallel to the vertical axis Aᵥ). As shown, the spreader blade 56 may be mechanically connected to or in mechanically communication with the drive assembly 30 (e.g., to be motivated or rotated by the same). In some embodiments, a drive assembly 30 comprises a spinner shaft 58 extending to the spreader blade 56 (e.g., along the blade axis A_{b}) in mechanical communication therewith to drive rotation of the spreader blade 56. Optionally, the spinner shaft 58 may be disposed forward from the element axis Aₑ (e.g., relative to the transverse axis Aₜ. Additionally or alternatively, the particulate exhaust 54 is disposed rearward from the spinner shaft 58.

Although a spreader blade 56 is illustrated, it is to be understood that the tool assembly 22 may include one or more additional or alternative tool units operably connected to the frame 20, e.g., a blade assembly when the power tool 10 is a mower, a snow thrower assembly when the power tool 10 is a snow thrower, etc.

Returning especially to FIG. 1, in some embodiments, the handle assembly 40 includes a grip portion having a plurality of handles such as a left handle 42 and a right handle 44. The left handle 42 and the right handle 44 may extend on opposite lateral sides with respect to a direction of movement of the traversing element 12. In some arrangements, the handle assembly 40 may include a central portion 46 between the left handle 42 and right handle 44. For instance, the left handle 42 and right handle 44 may extend from the central portion 46.

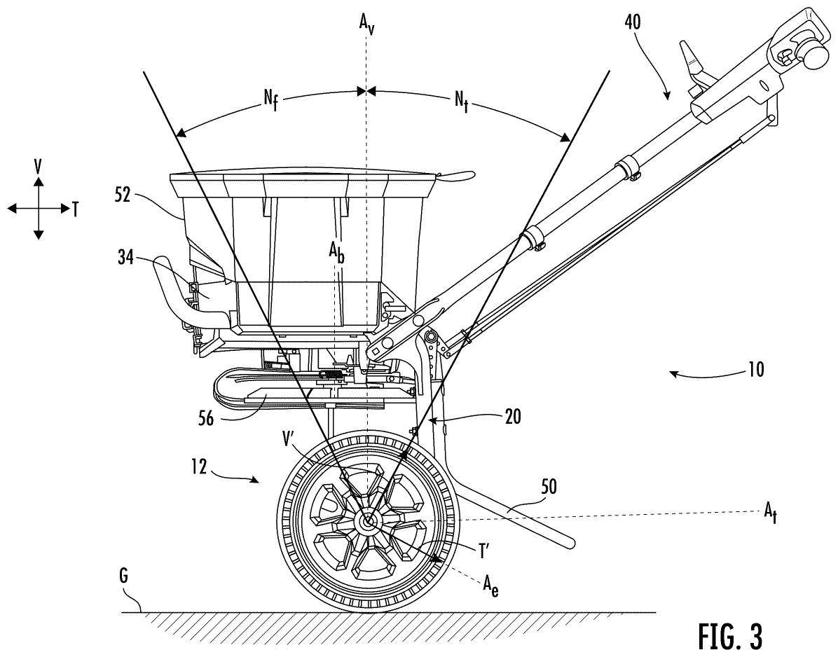

Turning now to FIGS. 2 through 8, the power tool 10 may generally be tiltable relative to the ground G between a storage state (e.g., FIGS. 2, 5, and 7) and a use state (e.g., FIGS. 3, 6, and 8). In particular, the power tool may tilt about the element axis Aₑ between a rearward storage state and a forward or upright use state. As the power tool tilts, it may further tilt relative to a mutually orthogonal vertical axis Aᵥ (e.g., parallel to a perfectly level, ground-defined vertical direction V) and a transverse axis Aₜ (e.g., parallel to a perfectly level, ground-defined transverse direction T), both of which are orthogonal to the element axis Aₑ and may extend therefrom. The tilt between the storage state and the use state may be defined by a predetermined tilt angle Nₜ extending about the element axis Aₑ.

In some embodiments, the storage state may provide or include the power tool 10 in a self-supporting position, such that a user is not in contact with the power tool 10 even while the traversing element 12 (e.g., wheels 14 and 16) remain in contact with the ground. For instance, the contact segment of the kickstand 50 may rest against the ground, propping up the tool 10 with the wheels 14, 16 (FIG. 1) and preventing the tool 10 from falling over.

In additional or alternative embodiments, the use state may provide or include the power tool 10 in an upright position to be supported by a user (e.g., gripping the handle assembly 40). In some such embodiments, the traversing element 12 or wheels 14 and 16 may be the only portion of the power tool 10 in contact with the ground G at the use state. As shown, the use state may include or provide the tool assembly in a position generally parallel to the ground G (e.g., lateral or transverse directions L or T). For instance, the use state may provide a rotational or blade axis A_{b} of the spreader blade 56 in an orientation that is generally parallel to the vertical direction V. The use state may optionally be configured to permit the hopper 52 to reach a maximum or rated volume of particulate within the receiving area (e.g., such that particulate does not spill from the hopper 52 assembly as motivated by gravity).

As shown, the power tool 10 may define a mutually orthogonal fixed vertical line V′, fixed lateral line L′ (FIG. 1), and fixed transverse line T′. All three lines V′, L′, and T′ may emanate, for instance, from a center point of the element axis Aₑ. In the use state, the vertical line V′ may be held generally parallel to the vertical direction V. The fixed lateral line L′ and fixed transverse line T′ may be held horizontally (e.g., parallel to the lateral direction L or the transverse direction T). In some embodiments, a forward-fall angle N_{f} is defined forward from the vertical line V′ to a secondary line defined as parallel to the vertical direction V at the storage state. Optionally, the forward-fall angle N_{f} may be equal in magnitude to the tilt angle Nₜ.

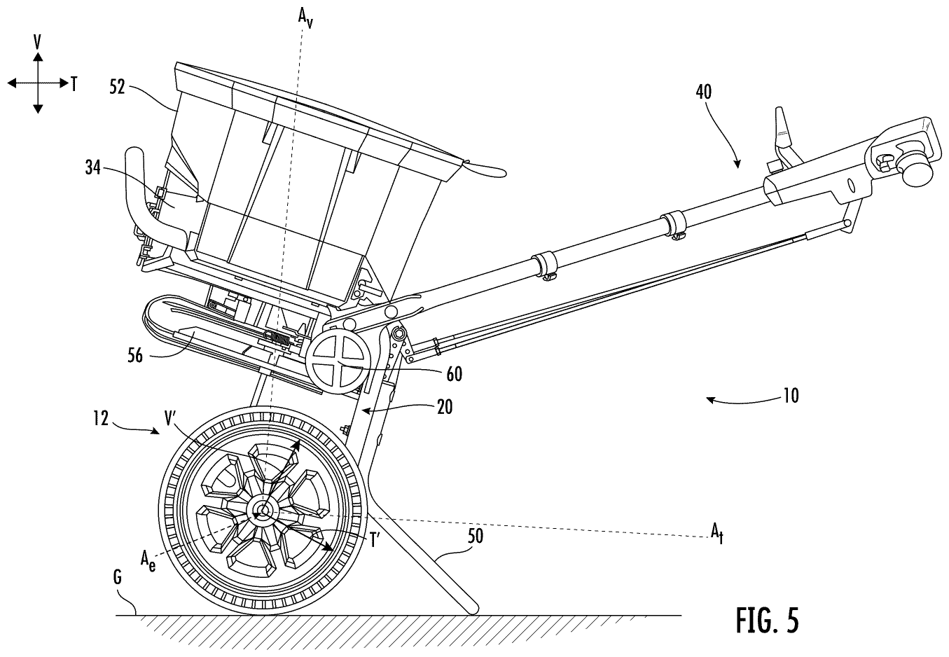

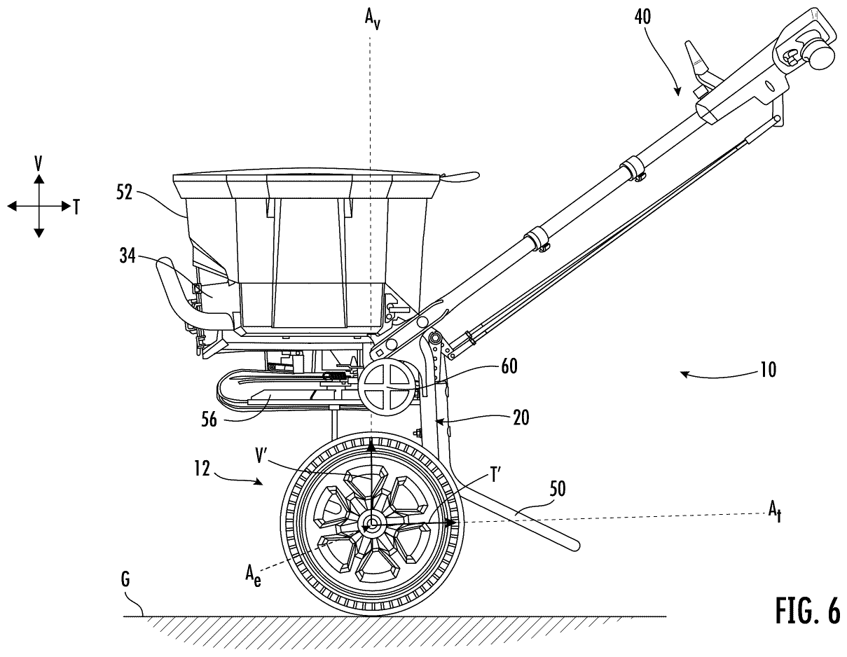

As an object having mass, the power tool 10 may further define a center of gravity (COG) 60. Moreover, COG 60 may be influenced by a particulate or stored mass provided to the receiving area or hopper 52. In particular, at least two discrete COG 60 locations may be predetermined. One (e.g., first) location of COG 60 may be set or predetermined according to an empty state of the hopper 52 (e.g., a state in which the assembled power tool 10 includes the hopper 52 substantially free of particulate therein)—see e.g., FIGS. 5 and 6. Another (e.g., second) location of COG 60 may be set or predetermined according to a loaded state of the hopper 52. Specifically, the loaded state may provide a predetermined mass of particulate or spreadable material (e.g., approximately 15, 18, 20, 23, 25, 27, or 38 kilograms; or a mass within 50%, 25%, or 10% of a rated capacity of the hopper 52).

In some embodiments, multiple discrete use states are defined. For instance, turning especially to FIG. 5, a first use state may be provided. As noted above, as a use state, the first use state may include the vertical line V′ being generally parallel to the vertical direction V. The fixed lateral line L′ and fixed transverse line T′ may be held horizontally (e.g., parallel to the lateral direction L or the transverse direction T). Additionally or alternatively, the first use state may include an empty state of the hopper 52. In the first use state, the COG 60 may be disposed along or rearward from the vertical axis Aᵥ (e.g., proximal to handle assembly 40 or distal to the direction of travel in comparison to the vertical axis Aᵥ). Optionally, the COG 60 may be disposed rearward from the forward-fall angle N_{f}. As shown, in the first use state, the COG 60 may be disposed above (e.g., at a higher relative height than) the element axis Aₑ. Optionally, the battery 34 may be supported on the frame 20 in the first use state, as described above (e.g., in electrical communication with the drive assembly 30). In some such embodiments, the battery 34 is mounted above the element axis Aₑ and forward from the vertical axis Aᵥ.

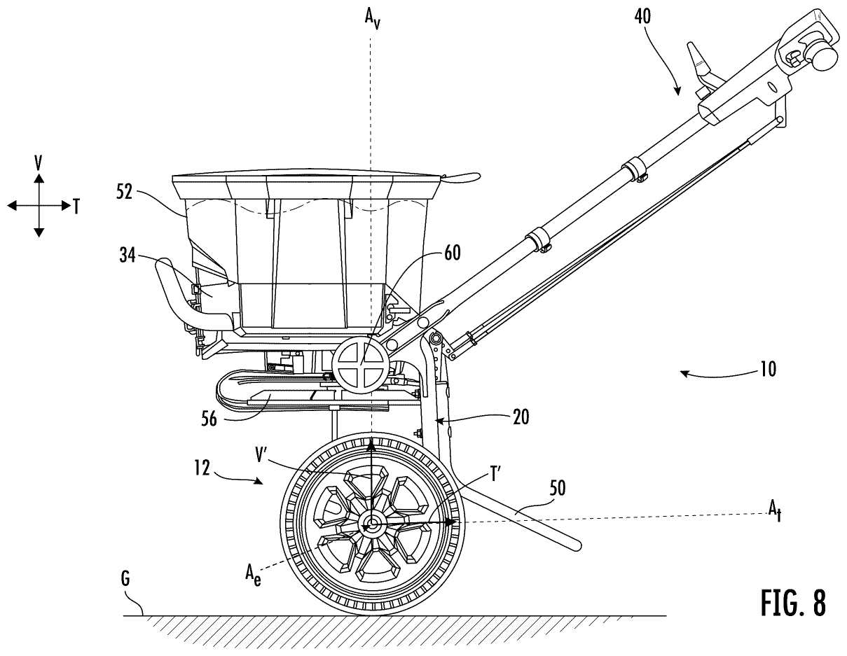

Turning now especially to FIG. 8, separate from or in addition to the first use state, a second use state may be provided. As noted above, as a use state, the second use state may include the vertical line V′ being generally parallel to the vertical direction V. The fixed lateral line L′ and fixed transverse line T′ may be held horizontally (e.g., parallel to the lateral direction L or the transverse direction T). Additionally or alternatively, the second use state may include a loaded state of the hopper 52 (e.g., such that a predetermined particulate mass is received within the hopper 52). In the second use state, the COG 60 may be disposed forward from the vertical axis Aᵥ (e.g., distal to handle assembly 40 or proximal to the direction of travel in comparison to the vertical axis Aᵥ). Optionally, the COG 60 may be disposed within the forward-fall angle N_{f}. As shown, in the second use state, the COG 60 may be disposed above (e.g., at a higher relative height than) the element axis Aₑ. The COG 60 at the second use state may be higher (e.g., relative to the vertical axis Aᵥ) than at the first use state. Optionally, the battery 34 may be supported on the frame 20 in the second use position, as described above (e.g., in electrical communication with the drive assembly 30). In some such embodiments, the battery 34 is mounted above the element axis Aₑ and forward from the vertical axis Aᵥ.

In additional or alternative embodiments, multiple discrete storage states may be defined. For instance, turning especially to FIG. 4, a first storage state may be provided. As noted above, as a storage state, the first storage state may include the vertical line V′ being tilted rearward relative to the vertical direction V according to the predetermined tilt angle Nₜ. Additionally or alternatively, the first storage state may include an empty state of the hopper 52. In the first storage state, the COG 60 may be disposed rearward from the vertical axis Aᵥ (e.g., proximal to handle assembly 40 or distal to the direction of travel in comparison to the vertical axis Aᵥ). For instance, the COG 60 may be disposed farther rearward in comparison to the first use state. Moreover, the COG 60 may be disposed rearward from the forward-fall angle N_{f}. As shown, in the first storage state, the COG 60 may be disposed above (e.g., at a higher relative height than) the element axis Aₑ. Optionally, the battery 34 may be supported on the frame 20 in the first storage state, as described above (e.g., in electrical communication with the drive assembly 30). In some such embodiments, the battery 34 is mounted above the element axis Aₑ and forward from the vertical axis Aᵥ.

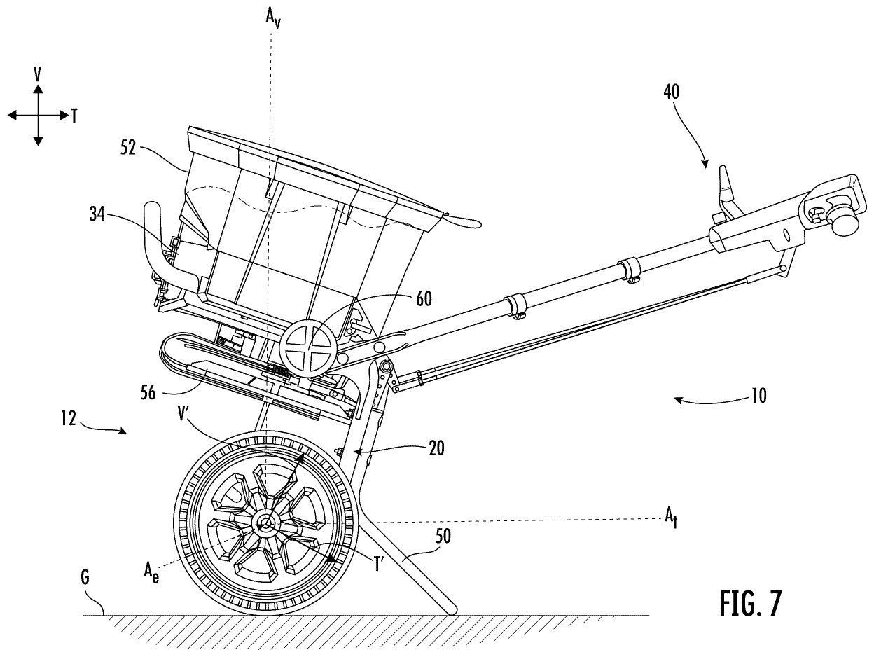

Turning now especially to FIG. 7, separate from or in addition to the first storage state, a second storage state may be provided. As noted above, as a storage state, the first storage state may include the vertical line V′ being tilted rearward relative to the vertical direction V according to the predetermined tilt angle Nₜ. Additionally or alternatively, the second storage state may include a loaded state of the hopper 52 (e.g., such that a predetermined particulate mass is received within the hopper 52). In the second storage state, the COG 60 may be disposed rearward from the vertical axis Aᵥ (e.g., proximal to handle assembly 40 or distal to the direction of travel in comparison to the vertical axis Aᵥ). For instance, the COG 60 may be disposed farther rearward in comparison to the second use state. Additionally or alternatively, the COG 60 may be disposed farther forward in comparison to the first storage state. Optionally, the COG 60 may be disposed within the forward-fall angle N_{f}. As shown, in the second storage state, the COG 60 may be disposed above (e.g., at a higher relative height than) the element axis Aₑ. The COG 60 at the second storage state may be higher (e.g., relative to the vertical axis Aᵥ) than at the first storage state. Optionally, the battery 34 may be supported on the frame 20 in the second storage position, as described above (e.g., in electrical communication with the drive assembly 30). In some such embodiments, the battery 34 is mounted above the element axis Aₑ and forward from the vertical axis Aᵥ.

Notably, the above-described embodiments may provide a forward-tilted balance when being used while being self-supporting or restable in a rearward tilted storage position. Additionally or alternatively, a user may be required to supply very little counterbalancing downward force, such as by resting his or her hands on the handle of the power tool.

Further aspects of the disclosure are provided by one or more of the following embodiments:

Embodiment 1. An outdoor power tool tiltable between a first storage state and a first use state, the outdoor power tool comprising: a frame; a tool assembly supported on the frame; a drive assembly supported on the frame below at least a portion of the tool assembly; a traversing element movably attached to the frame and defining an element axis about which the traversing element moves, the traversing element further defining a vertical axis orthogonal to the element axis and a transverse axis orthogonal to the element axis and the vertical axis; and a handle assembly attached to the frame and extending rearward therefrom, wherein the outdoor power tool defines a center of gravity, wherein, in the first use state, the center of gravity is disposed along or rearward from the vertical axis.

Embodiment 2. The power tool of any one or more of the embodiments, wherein, in the first storage state, the center of gravity is disposed rearward from the vertical axis.

Embodiment 3. The power tool of any one or more of the embodiments, wherein, in the first storage state and the first use state, the center of gravity is disposed above the element axis.

Embodiment 4. The power tool of any one or more of the embodiments, further comprising a kickstand extending rearward and downward from the frame in support thereof at the first storage state.

Embodiment 5. The power tool of any one or more of the embodiments, wherein the tool assembly comprises a spreader blade disposed above the traversing element, wherein the drive assembly comprises a spinner shaft extending to the spreader blade in mechanical communication therewith to drive blade rotation.

Embodiment 6. The power tool of any one or more of the embodiments, wherein the spinner shaft is disposed forward from the element axis.

Embodiment 7. The power tool of any one or more of the embodiments, wherein the tool assembly comprises a hopper disposed above the element axis, wherein the hopper defines a particulate exhaust to release particulate material therefrom, and wherein the particulate exhaust is disposed rearward from the spinner shaft.

Embodiment 8. The power tool of any one or more of the embodiments, wherein the drive assembly comprises a motor in mechanical communication with the traversing element to drive rotation of the traverse element about the element axis.

Embodiment 9. The power tool of any one or more of the embodiments, wherein the tool assembly comprises a hopper disposed above the element axis and extending forward from the vertical axis, wherein the outdoor power tool is further movable to a second storage state and a second use state, wherein the first use state and the first storage state comprise an empty state of the hopper, wherein the second use state and second storage state comprise a predetermined particulate mass received within the hopper, and wherein, in the second use state, the center of gravity is disposed forward from the vertical axis.

Embodiment 10. The power tool of any one or more of the embodiments, wherein, in the second storage state, the center of gravity is disposed rearward from the vertical axis.

Embodiment 11. The power tool of any one or more of the embodiments, further comprising a battery supported on the frame in electrical communication with the drive assembly.

Embodiment 12. The power tool of any one or more of the embodiments, wherein the battery is mounted above the element axis and forward from the vertical axis.

Embodiment 13. An outdoor power tool tiltable between a first storage state and a first use state, the outdoor power tool comprising: a frame; a tool assembly supported on the frame; a traversing element movably attached to the frame and defining an element axis about which the traversing element moves, the traversing element further defining a vertical axis orthogonal to the element axis and a transverse axis orthogonal to the element axis and the vertical axis ; a spreader blade disposed above the traversing element; a drive assembly supported on the frame and comprising a spinner shaft extending to the spreader blade in mechanical communication therewith to drive blade rotation, the spinner shaft being disposed forward from the element axis; and a handle assembly attached to the frame and extending rearward therefrom, wherein the outdoor power tool defines a center of gravity, wherein, in the first use state, the center of gravity is disposed along or rearward from the vertical axis, wherein, in the first storage state, the center of gravity is disposed rearward from the vertical axis, and wherein, in the first storage state and the first use state, the center of gravity is disposed above the element axis.

Embodiment 14. The power tool of any one or more of the embodiments, further comprising a kickstand extending rearward and downward from the frame in support thereof at the first storage state.

Embodiment 15. The power tool of any one or more of the embodiments, wherein the tool assembly comprises a hopper disposed above the element axis, wherein the hopper defines a particulate exhaust to release particulate material therefrom, and wherein the particulate exhaust is disposed rearward from the spinner shaft.

Embodiment 16. The power tool of any one or more of the embodiments, wherein the drive assembly comprises a motor in mechanical communication with the traversing element to drive rotation of the traverse element about the element axis.

Embodiment 17. The power tool of any one or more of the embodiments, wherein the tool assembly comprises a hopper disposed above the element axis and extending forward from the vertical axis, wherein the outdoor power tool is further movable to a second storage state and a second use state, wherein the first use state and the first storage state comprise an empty state of the hopper, wherein the second use state and second storage state comprise a predetermined particulate mass received within the hopper, and wherein, in the second use state, the center of gravity is disposed forward from the vertical axis.

Embodiment 18. The power tool of any one or more of the embodiments, wherein, in the second storage state, the center of gravity is disposed rearward from the vertical axis.

Embodiment 19. The power tool of any one or more of the embodiments, further comprising a battery supported on the frame in electrical communication with the drive assembly.

Embodiment 20. The power tool of any one or more of the embodiments, wherein the battery is mounted above the element axis and forward from the vertical axis.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An outdoor power tool tiltable between a first storage state and a first use state, the outdoor power tool comprising:
a frame;
a tool assembly supported on the frame;
a drive assembly supported on the frame below at least a portion of the tool assembly;
a traversing element movably attached to the frame and defining an element axis about which the traversing element moves, the traversing element further defining a vertical axis orthogonal to the element axis and a transverse axis orthogonal to the element axis and the vertical axis; and
a handle assembly attached to the frame and extending rearward therefrom,
wherein the outdoor power tool defines a center of gravity,
wherein, in the first use state, the center of gravity is disposed along or rearward from the vertical axis.

2. The outdoor power tool of claim 1, wherein, in the first storage state, the center of gravity is disposed rearward from the vertical axis.

3. The outdoor power tool of claim 1, wherein, in the first storage state and the first use state, the center of gravity is disposed above the element axis.

4. The outdoor power tool of claim 1, further comprising a kickstand extending rearward and downward from the frame in support thereof at the first storage state.

5. The outdoor power tool of claim 1, wherein the tool assembly comprises a spreader blade disposed above the traversing element, wherein the drive assembly comprises a spinner shaft extending to the spreader blade in mechanical communication therewith to drive blade rotation.

6. The outdoor power tool of claim 5, wherein the spinner shaft is disposed forward from the element axis.

7. The outdoor power tool of claim 5, wherein the tool assembly comprises a hopper disposed above the element axis,
wherein the hopper defines a particulate exhaust to release particulate material therefrom, and
wherein the particulate exhaust is disposed rearward from the spinner shaft.

8. The outdoor power tool of claim 1, wherein the drive assembly comprises a motor in mechanical communication with the traversing element to drive rotation of the traverse element about the element axis.

9. The outdoor power tool of claim 1, wherein the tool assembly comprises a hopper disposed above the element axis and extending forward from the vertical axis,
wherein the outdoor power tool is further movable to a second storage state and a second use state,
wherein the first use state and the first storage state comprise an empty state of the hopper,
wherein the second use state and second storage state comprise a predetermined particulate mass received within the hopper, and
wherein, in the second use state, the center of gravity is disposed forward from the vertical axis.

10. The outdoor power tool of claim 9, wherein, in the second storage state, the center of gravity is disposed rearward from the vertical axis.

11. The outdoor power tool of claim 1, further comprising a battery supported on the frame in electrical communication with the drive assembly.

12. The outdoor power tool of claim 11, wherein the battery is mounted above the element axis and forward from the vertical axis.

13. An outdoor power tool tiltable between a first storage state and a first use state, the outdoor power tool comprising:
a frame;
a tool assembly supported on the frame;
a traversing element movably attached to the frame and defining an element axis about which the traversing element moves, the traversing element further defining a vertical axis orthogonal to the element axis and a transverse axis orthogonal to the element axis and the vertical axis;
a spreader blade disposed above the traversing element;
a drive assembly supported on the frame and comprising a spinner shaft extending to the spreader blade in mechanical communication therewith to drive blade rotation, the spinner shaft being disposed forward from the element axis; and
a handle assembly attached to the frame and extending rearward therefrom,
wherein the outdoor power tool defines a center of gravity,
wherein, in the first use state, the center of gravity is disposed along or rearward from the vertical axis,
wherein, in the first storage state, the center of gravity is disposed rearward from the vertical axis, and
wherein, in the first storage state and the first use state, the center of gravity is disposed above the element axis.

14. The outdoor power tool of claim 13, further comprising a kickstand extending rearward and downward from the frame in support thereof at the first storage state.

15. The outdoor power tool of claim 13, wherein the tool assembly comprises a hopper disposed above the element axis,
wherein the hopper defines a particulate exhaust to release particulate material therefrom, and
wherein the particulate exhaust is disposed rearward from the spinner shaft.

16. The outdoor power tool of claim 13, wherein the drive assembly comprises a motor in mechanical communication with the traversing element to drive rotation of the traverse element about the element axis.

17. The outdoor power tool of claim 13, wherein the tool assembly comprises a hopper disposed above the element axis and extending forward from the vertical axis,
wherein the outdoor power tool is further movable to a second storage state and a second use state,
wherein the first use state and the first storage state comprise an empty state of the hopper,
wherein the second use state and second storage state comprise a predetermined particulate mass received within the hopper, and
wherein, in the second use state, the center of gravity is disposed forward from the vertical axis.

18. The outdoor power tool of claim 17, wherein, in the second storage state, the center of gravity is disposed rearward from the vertical axis.

19. The outdoor power tool of claim 13, further comprising a battery supported on the frame in electrical communication with the drive assembly.

20. The outdoor power tool of claim 19, wherein the battery is mounted above the element axis and forward from the vertical axis.
